(19) United States
(12) Patent Application Publication
(10) Pub. No.: US 2014/0269194 A1
(43) Pub. Date: Sep. 18, 2014

(54) Three Dimensional Touch by Acoustic Waves

(71) Applicant: INPUTEK INC., Hsinchu County (TW)

(72) Inventors: Chun Yu CHEN, Hsinchu County (TW); Chang Kuang CHUNG, Hsinchu County (TW)

(73) Assignee: INPUTEK INC., Hsinchu County (TW)

(21) Appl. No.: 13/846,240

(22) Filed: Mar. 18, 2013

(51) Int. Cl. H04B 11/00

(52) U.S. Cl. CPC H04B 11/00
USPC 367/117

(57) ABSTRACT

The three-dimensional touch system by acoustic waves comprises of a plurality of sensors and their controllers. The three-dimensional touch system implements the any or a combination of three different sensing methods. The first is an active wave triangulation location method that involves a plurality of receivers and an active wave transceiver. The second is a passive wave triangulation location method that involves a plurality of transceivers and a passive wave receiver. The last method, multi-triangulation location, uses different transceivers (or receivers) to input a multitude of different acoustic waves. Also, it is important that a calibration system be used to ensure that the transceivers and receivers are accurate in their readings.

### FIELD OF THE INVENTION

The present invention relates generally to an interactive three dimensional display technology with an integrated multi-touch device based on acoustic sensor technology.

### BACKGROUND OF THE INVENTION

Currently, there are interactive 2D devices that are well known in the industry like touch sensor, keyboard, mouse and touch pad. While the 3D display technology migrates, people can enjoy more vivid 3D images as well as the video. Having a simple multi-touch device will soon become a need for interacting with 3D images.

Traditionally, people use an image capturer to compare the differences of the images to tell the actions. However, it is more difficult to detect smaller and more delicate actions, such as a finger click, on a device such as the image capturer. The present invention uses the acoustic waves to calculate the relative positions that people want to present. The acoustic waves are easy to generate from band to band.

People can use the different waves as different “input-keys” to perform create multi-touch. Moreover, the cost to generate and compare the acoustic waves is much cheaper and easier than comparing the images.

### BRIEF DESCRIPTION OF THE DRAWINGS

FIG. 1 is a diagram depicting an active wave triangulation location method.

FIG. 2 is a diagram depicting a passive wave triangulation location method.

FIG. 3 is a diagram depicting a multi-triangulation location method.

FIG. 4 is a schematic diagram of the interaction between a screen, a transceiver or receiver, and a computer.

### DETAIL DESCRIPTIONS OF THE INVENTION

All illustrations of the drawings are for the purpose of describing selected versions of the present invention and are not intended to limit the scope of the present invention.

The present invention relies heavily on the interaction between sensors and their remote controls. There are several methods in which the use of sensors, specifically acoustic transceivers and receivers, can create a platform for interactive three-dimensional technology. Such methods include an active wave triangulation location, a passive wave triangulation location, and multi-triangulation location. By using the relationship between a transceiver and a receiver for detecting a plurality of acoustic waves 31, the present invention is able to calculate the relative positions that the user wants to present.

Acoustic waves 31 are longitudinal waves whose method of motion relies on adiabatic compression and decompression. A benefit of using acoustic waves 31 is that it enables more sensitive readings of the positions. Therefore, it makes the entire device much more sensitive to smaller movements, and as a result, much more accurate. Also, another benefit of using acoustic waves 31 is the ability to generate easily from band to band. This quick and rapid generation of acoustic waves can lead to performing multi-touch, which can hasten the productivity of the present invention. This will lead to faster and higher quality interactive three-dimensional imaging.

Referring to FIG. 1 and FIG. 4, the first method, the active wave triangulation location comprises of a plurality of receivers 14 and an active wave transceiver 3. The plurality of receivers 14 must first be installed onto the television screen 9. A left active wave receiver 1 is placed on one corner of the screen 9 and a right active wave receiver 2 is placed directly across from the left active wave receiver 1, which means the distance, a horizontal active wave distance 25, between the two receivers is known. The present embodiment uses, but is not limited to, a television screen 9. Other screens that can be used may even include projector screens. The acoustic active wave transceiver 3, which is held by the user, can be placed a certain distance away from the front of the television screen 9, thereby placing it also a certain distance, a left active wave distance 23 and a right active wave distance 24, away from the left active wave receiver 1 and the right active wave receiver 2, respectively. By doing so, both the left active wave receiver 1 and the right active wave receiver 2 are able to detect each acoustic wave transmitted by the active wave transceiver 3. The time that it takes for each acoustic wave 31 that is transmitted from the active wave transceiver 3 to reach the left active wave receiver 1 with the time it takes for each acoustic wave 31 to reach the right active wave receiver 2 can easily be compared. This comparison can result in the calculation of the distance between each receiver 14 and the active wave transceiver 3. Through this interaction, the plurality of receivers 14 can obtain data regarding the left active wave distance 23 between the left active wave receiver 1 and the active wave transceiver 3, the right active wave distance 24 the right active wave receiver 2, and the active wave transceiver 3, and the horizontal active wave distance 25 the left active wave receiver 1 and the right active wave receiver 2.

Through a formula for the coordinates of the active wave transceiver 3 or the passive wave receiver 7:

D(X_{D},Y_{D}):

X_{D}=X_{B}+BD*sin(ABD)=X_{A}+AD*sin(BAD)

Y_{D}=Y_{B}+BD*cos(ABD)=Y_{C}+AD*cos(BAD)

cos ABD=(AB²+BD²−AD²)/(2AB*BD)

where,
X_{D} is the horizontal position of active wave transceiver 3 or passive wave receiver 7;
X_{B} is the horizontal position of right active wave receiver 2 or right passive wave transceiver 6;
X_{A} is the horizontal position of left active wave receiver 1 or left passive wave transceiver 5;
Y_{D} is the vertical position of active wave transceiver 3 or passive wave receiver 7;
Y_{B} is the vertical position of right active wave receiver 2 or right passive wave transceiver 6;
Y_{C} is the vertical position of bottom active wave receiver 4 or bottom passive wave transceiver 8;
AB represents a horizontal active wave distance 25 between the left active wave receiver 1 and the right active wave receiver 2 or a horizontal passive wave distance 30 between the left passive wave transceiver 5 and the right passive wave transceiver 6;
BD represents a right active wave distance 24 between the right active wave receiver 2 and the active wave transceiver 3 or a right passive wave distance 29 between the right passive wave transceiver 6 and the passive wave receiver 7;
AD represents a left active wave distance 23 between the left active wave receiver 1 and the active wave transceiver 3 or a left passive wave distance 28 between the left passive wave transceiver 5 and the passive wave receiver 7;
ABD represents a right horizontal active wave angle 26 at a vertex for the right active wave receiver 2 from a triangle created by the left active wave receiver 1, the right active wave receiver 2, and the active wave transceiver 3 or a right horizontal passive wave angle 26 at a vertex for the right passive wave transceiver 6 form the triangle created by the left passive wave transceiver 5, the right passive wave transceiver 6, and the passive wave receiver 7;
BAD is a left horizontal active wave angle 22 at the vertex for the left active wave receiver 1 from the triangle created by the right active wave receiver 2, the left active wave receiver 1, and the active wave transceiver 3 or a left horizontal passive wave angle 27 at the vertex for the left passive wave transceiver 5 from the triangle created by the right passive wave transceiver 6, the left passive wave transceiver 5, and the passive wave receiver 7;
the coordinates for the active wave transceiver 3 or the passive wave receiver 7 can be found.

In regards to the active wave triangulation methods, the horizontal active wave angle 11 can help determine the distance between the pair of receivers 14 and the active wave transceiver 3. The horizontal active wave angle 11 and distance between each transceiver 3 to the receiver 14 has an inverse relationship. As the horizontal active wave angle 11 increases, the distances between the receivers 14 to the active wave transceiver 3 will decrease. If another receiver, a bottom active wave receiver 4, was placed on the screen, directly below the one of the receivers, for example, the right active wave receiver 2, an active wave source 32, which is the active wave transceiver 3 is doing a vertical motion to change the horizontal active wave angle 11. Similar to how data was retrieved from the horizontal active wave triangle 13 (created by left active wave receiver 1, right active wave receiver 2, and active wave transceiver 3), data can also be retrieved from a vertical active wave triangle 15 (created by right active wave receiver 2, bottom active wave receiver 4, and active wave transceiver 3). By comparing the vertical active wave angle 18 that is a result of the vertical active wave triangle 15, to the horizontal active wave angle 11, users can determine if the active wave source 32, is moving in a vertical motion. This will help to determine if there is any change in the horizontal active wave angle 11.

Referring to FIG. 2 and FIG. 4, another method is to use a passive wave triangulation location. The concept behind the passive wave triangulation location is very similar to the active wave triangulation location. Instead of having receivers on the screen, there are a minimum of two transceivers on the television. A left passive wave transceiver 5 and a right passive wave transceiver 6 account for the acoustic wave source 32 to a passive wave receiver 7. Since the distance between the plurality of transceivers 17 which is the horizontal passive wave distance 30, is a fixed, known distance, the left passive wave distance 28, which is the distance between left passive wave transceiver 5 and the passive wave receiver 7 as well as the right passive wave distance 29, which is the distance between the right passive wave transceiver 6 and the passive wave receiver 7 can be determined as well. Mainly by counting the time it takes between each acoustic wave 31 to reach the passive wave receiver 7 held by the user, the distances between left passive wave transceiver 5 and passive wave receiver 7 and between right passive wave transceiver 6 and passive wave receiver 7 can be determined. Then, by using the same formula as mentioned, the location at which the passive wave receiver 7 is being held by the user is determined by calculating the location of the x and y coordinates. Also, the convenience of the passive wave receiver 7 is that it can also simultaneously send information and data directly to the computer 10. This is useful because being able to directly connect to the computer 10 can ensure quicker feedback from the present invention. The constant exchange of information creates better interaction between the transceivers and receivers without much delay, resulting in better results of the present invention will be.

Again referring to FIG. 2 and FIG. 4, the passive wave triangulation location method also makes use of the same principles as used in the active wave triangulation location method. For example, if the horizontal passive wave angle 12 increases, it is because the passive wave receiver 7 is close to the active wave source 32, which is being transmitted from both the left passive wave transceiver 5 and the right passive wave transceiver 6. Similar to triangle geometry, if two vertices (in this case, left passive wave transceiver 5 and right passive wave transceiver 6) or positions are fixed, then the distance between the same two vertices is also fixed. Since the third vertex (in this case, the position of the passive wave receiver 7) is not fixed, the distance between each of the fixed vertices (left passive wave transceiver 5 and right passive wave transceiver 6) to the position of the passive wave receiver 7 is also not fixed. Therefore, as the distance between each transceiver 17 and the passive wave receiver 7 decreases, the horizontal passive wave angle 12 increases. Also, the horizontal passive wave angle 12 increasing implies that the position of the passive wave receiver 7 is close to the transceivers 17. This is because while the passive wave receiver 7 travels closer to the screen 9, the distances between each of the transceivers 17 to the passive wave receiver 7 decreases, causing the angle between the two to increase. Also, similar to the versatility of the active wave triangulation, a bottom passive wave transceiver 8 can be used to create a vertical passive wave triangle 20 with the already established right passive wave transceiver 6 and the passive wave receiver 7. By comparing the vertical passive angle 19 with the horizontal passive angle 12 from the horizontal passive wave triangle 16, it can be known whether the acoustic wave source 32 is creating a vertical motion that could change the horizontal passive angle 12.

In reference to FIG. 3, the next method is through multi-triangulation location. This involves incorporating the previous two methods, but increasing the amount of either active wave transceivers 3 or passive wave receivers 7 for the user, depending on which of the two previously mentioned methods were chosen. The multi-triangulation location method enables the reading of multiple positions of the active wave transceivers 3 (or passive wave receivers 7) simultaneously because there are many different acoustic waves 31 being transmitted to the computer 10 at the same time. Also, since the active wave transceivers 3 (or passive wave receivers 7) can directly connect to the computer 10, the varying positions can be recorded immediately. This is useful because it increases the number of acoustic waves 31 that can be transmitted from the active wave transceivers 3 (or passive wave receivers 7) to the receivers 14 (or transceivers 17) at a time. This increases the speed at which the device can be used, as well as the functionality.

Another component of the three-dimensional touch system is its calibration system. The computer 10 that will be used to read the acoustic waves will need to be calibrated in order to accurately read the varying acoustic waves. This enables the computer 10 to learn the user behavior and the waving length of the specific user. And since each user is different, the device will need to be calibrated several times. The user should create at least two points at different positions, the computer 10 will be able to learn the relative points the user wants to present. The benefit of calibrating the system is to create better quality interactive three dimensional imaging. By being able to do this calibration, the results of the system will be accurate, because the calibrating the system will help remove the possible build-up of errors that could arise from a lack of calibration.

Although the invention has been explained in relation to its preferred embodiment, it is to be understood that many other possible modifications and variations can be made without departing from the spirit and scope of the invention as hereinafter claimed.

What is claimed is:

1. A method for a calibration for a three-dimensional touch system by acoustic waves comprises of the steps:
Positioning an active wave transceiver or a passive wave receiver at varying distances away from a plurality of active wave receivers or a plurality of passive wave transceivers;
Wherein the plurality of receivers comprises of a left active wave receiver, a right active wave receiver, and a bottom active wave receiver, and the plurality of passive wave transceivers comprises of a left passive wave transceiver, a right passive wave transceiver, and a bottom passive wave transceiver;
Activating the active wave transceiver or the passive wave receiver at varying distances away from the plurality of active wave receivers or the plurality of passive wave transceivers;
Transferring of a sample data between the plurality of active wave receivers and a computer or between the plurality of passive wave transceivers and the computer; and
Calibrating the active wave transceiver and the plurality of active wave receivers or the passive wave receiver and the plurality of passive wave transceivers.

2. A method for a location of an active wave transceiver or a passive wave receiver comprises of the steps:
Calculating a pair of coordinates for the location of the active wave transceiver or the passive wave receiver with a formula for a vertical coordinate and a horizontal coordinate of said active wave transceiver or said passive wave receiver:
$$D ( {X}_{D} , {Y}_{D} )$$
$$\begin{matrix}{X}_{D} = {X}_{B} + BD sin ( ABD ) \\ = {X}_{A} + AD sin ( BAD )\end{matrix}$$
$$\begin{matrix}{Y}_{D} = {Y}_{B} + BD cos ( ABD ) \\ = {Y}_{C} + AD cos ( BAD )\end{matrix}$$
$$cos ( ABD ) = \frac{{AB}^{2} + {BD}^{2} - {AD}^{2}}{2 AB * BD}$$
Where X_{D} represents a horizontal position of the active wave transceiver or the passive wave receiver and Y_{D} represents a vertical position of said active wave transceiver or the passive wave receiver; X_{B} represents a horizontal position of the right active wave receiver or the right passive wave transceiver and Y_{B} represents a vertical position of said right active wave receiver or of said passive wave transceiver; X_{A} represents a horizontal position of the left active wave receiver or the left passive wave transceiver; Y_{C} represents a vertical position of the bottom active wave receiver or the bottom passive wave transceiver; AB represents a horizontal active wave distance between the left active wave receiver and the right active wave receiver or a horizontal passive wave distance between the left passive wave transceiver and the right passive wave transceiver; BD represents a right active wave distance between the right active wave receiver and the active wave transceiver or a right passive wave distance between the right passive wave transceiver and the passive wave receiver; AD represents a left active wave distance between the left active wave receiver and the active wave transceiver or a left passive wave distance between the left passive wave transceiver and the passive wave receiver; ABD represents a right horizontal active wave angle at a vertex for the right active wave receiver from a triangle created by the left active wave receiver, the right active wave receiver, and the active wave transceiver or a right horizontal passive wave angle at a vertex for the right passive wave transceiver form the triangle created by the left passive wave transceiver, the right passive wave transceiver, and the passive wave receiver; BAD is a left horizontal active wave angle at the vertex for the left active wave receiver from the triangle created by the right active wave receiver, the left active wave receiver, and the active wave transceiver or a left horizontal passive wave angle at the vertex for the left passive wave transceiver from the triangle created by the right passive wave transceiver, the left passive wave transceiver, and the passive wave receiver.

3. A method for the active wave triangulation comprises of the following steps:
Existing of a vertical active wave distance between the right active wave receiver and the bottom active wave receiver;
Wherein positions of the left active wave receiver, the right active wave receiver, and the bottom active wave receiver are fixed;
Transmitting a plurality of acoustic waves by the active wave transceiver;
Receiving the plurality of acoustic waves by the plurality of active wave receivers; and
Transmitting data about the horizontal active wave distance, the vertical active wave distance, and the plurality of acoustic waves from the plurality of active wave receivers to the computer.

4. The method for the active wave triangulation as claimed in claim 3 comprises,
Exchanging information about the plurality of acoustic waves between the plurality of active wave receivers and the active wave transceiver;
Wherein the active wave transceiver transmits each acoustic wave and each of the active wave receivers receives each acoustic wave;
Tracking an amount of time it takes for each acoustic wave to reach each active wave receiver; and
Comparing the amount of time it takes each acoustic wave to reach each active wave receiver to generate distance between each active wave receiver to the active wave transceiver.

5. The method for the active wave triangulation as claimed in claim 4 comprises,
Comparing the horizontal active wave angle with a vertical active wave angle to determine a vertical motion of an acoustic wave source; and
Wherein the vertical active wave angle is a vertex at the active wave transceiver of a triangle created by the right active wave receiver, the bottom active wave receiver, and the active wave transceiver and the acoustic wave source is the active wave transceiver.

6. The method for the active wave triangulation as claimed in claim 5 comprises,
Exchanging acoustic wave, receiver and transceiver data between the computer and the plurality of active wave receivers;
Emitting a vivid three-dimensional image at a chosen relative position;
Wherein the chosen relative position is a predetermined location; and
Interacting with the vivid three-dimensional image.

7. A method for the passive wave triangulation comprises of the following steps:
Existing of a vertical passive wave distance between the right passive wave transceiver and the bottom passive wave transceiver;
Wherein positions of the left passive wave transceiver, the right passive wave transceiver, and the bottom passive wave transceiver are fixed;
Transmitting the plurality of acoustic waves by the plurality of passive wave transceivers;
Receiving the plurality of acoustic waves by the passive wave receiver; and
Transmitting data about the horizontal passive wave distance, the vertical passive wave distance, and the plurality of acoustic waves from the passive wave receiver to the computer.

8. The method for the passive wave triangulation as claimed in claim 7 comprises,
Exchanging information about the plurality of acoustic waves between the plurality of passive wave transceivers and the passive wave receiver;
Wherein each passive wave transceiver transmits each acoustic wave and the passive wave receiver receives said acoustic wave;
Tracking an amount of time it takes for each acoustic wave to reach each transceiver; and
Comparing the amount of time it takes each acoustic wave to reach each passive wave transceiver to generate distance between each passive wave transceiver to the passive wave receiver.

9. The method for the passive wave triangulation as claimed in claim 8 comprises,
Comparing the horizontal passive wave angle with a vertical passive wave angle to determine a vertical motion of the active wave source; and
Wherein the vertical passive wave angle is a vertex at the passive wave receiver of a triangle created by the right passive wave transceiver, the bottom passive wave transceiver, and the passive wave receiver and the active wave source is each passive wave transceiver.

10. The method for the passive wave triangulation as claimed in claim 9 comprises,
Exchanging acoustic wave, receiver and transceiver data between the computer and the passive wave receiver;
Emitting the vivid three-dimensional image at the chosen relative position; and
Interacting with the vivid three-dimensional images.

11. A method for multi-triangulation comprises of the following steps:
Existing of the horizontal passive wave distance between the left passive wave transceiver and the right passive wave transceiver or of the horizontal active wave distance between the left active wave receiver and the right active wave receiver;
Existing of the vertical passive wave distance between the right passive wave transceiver and the bottom passive wave transceiver or of the vertical active wave distance between the right active wave receiver and the bottom active wave receiver;
Wherein positions of the left passive wave transceiver, the right passive wave transceiver, and the bottom passive wave transceiver are fixed or positions of the left active wave receiver, the right active wave receiver, and the bottom active wave receiver are fixed;
Transmitting the plurality of acoustic waves by each passive wave transceiver or each active wave transceiver;
Receiving the plurality of acoustic waves by each passive wave receiver or each active wave receivers; and
Transmitting data about the horizontal passive wave distance, the vertical passive wave distance, and the plurality of acoustic waves from each passive wave receiver to the computer or about the horizontal active wave distance, the vertical active wave distance, and the plurality of acoustic waves from each active wave receiver to the computer.

12. The method for multi-triangulation as claimed in claim 11 comprises,
Exchanging of information about the plurality of acoustic waves between each active wave receiver and each active wave transceiver or each passive wave receiver and each passive wave transceiver;
Wherein each active wave transceiver or each passive wave transceiver transmits an acoustic wave and each active wave receiver or each passive wave receiver receives said acoustic wave;
Tracking an amount of time it takes for each acoustic wave to reach each active wave receiver or each passive wave receiver; and
Comparing the amount of time it takes each acoustic wave to reach each receiver to generate the distance between each left active wave receiver or each left passive wave transceiver to each active wave transceiver or each passive wave receiver, respectively, or the distance between each right active wave receiver or each right passive wave transceiver to each active wave transceiver or each passive wave receiver, respectively, or the distance between each bottom active wave receiver or each bottom passive wave transceiver to each active wave transceiver or each passive wave receiver, respectively.

13. The method for multi-triangulation as claimed in claim 12 comprises,
Comparing the horizontal active wave angle with the vertical active wave angle or the horizontal passive wave angle with the vertical passive wave angle determine the vertical motion of the acoustic wave source; and
Wherein the acoustic wave source is each active wave transceiver or each passive wave transceiver.

14. The method for multi-triangulation as claimed in claim 13 comprises,
Exchanging acoustic wave, receiver and transceiver data between the computer and the plurality of receivers;
Emitting a plurality of vivid three-dimensional images at a plurality of chosen relative positions;
Wherein the plurality of chosen relative positions are predetermined locations; and
Interacting with the plurality of vivid three-dimensional images.
